(19) United States
(12) Patent Application Publication
(10) Pub. No.: US 2015/0125778 A1
(43) Pub. Date: May 7, 2015

(54) CONNECTING DEVICE FOR A FUEL CELL AND FUEL CELL FITTED WITH SUCH A DEVICE

(71) Applicant: Pragma Industries, Bidart (FR)

(72) Inventor: Mario Abadie, Anglet (FR)

(73) Assignee: Pragma Industries a corporation

(21) Appl. No.: 14/398,147

(22) PCT Filed: May 3, 2013
(86) PCT No.: PCT/EP2013/059221

§ 371 Date: Oct. 31, 2014

(30) Foreign Application Priority Data
May 3, 2012 (FR) 1254056

(51) Int. Cl. H01M 8/24; H01M 8/00

(52) U.S. Cl. CPC H01M 8/2475; H01M 8/2485; H01M 8/004
USPC 429/458

(57) ABSTRACT

A connecting device for a fuel cell including a cell carrier strip wound into a spiral, the device includes a tube provided with an electrically conductive outer surface and an axial electric connection terminal, as well as with a connection terminal for a first gas and radial ports for the passage of the first gas. The tube forms a channel for the distribution of the first gas between the connection terminal for the first gas and the radial ports. In addition, the device includes an electrically insulating sleeve for receiving the tube, the sleeve being provided with an open longitudinal window opposite the ports on one side of the sleeve.

### CROSS REFERENCE TO RELATED APPLICATION

This application is the National Stage of International Application No. PCT/EP2013/059221 having International filing date 3 May 2013, which designated the United States of America, and which International Application was published under PCT Article 21(s) as WO Publication 2013/164438 A1 and which claims priority from, and benefit of, French Application No. 1254056 filed on 3 May 2012 the disclosures of which are incorporated herein by reference in their entireties.

### BACKGROUND

The presently disclosed embodiment relates to a fuel cell connection device and a fuel cell fitted with such a device.

The disclosed embodiment applies in particular to a fuel cell comprising a strip bearing a plurality of unitary cells connected together in a wound form.

Fuel cells comprising a wound unitary-cell-bearing strip are notably described in the documents FR 2 880 994 A1 and FR 2 958 800 A1 in the name of the applicant.

### SUMMARY

For the connection of such a cell, it is important to consider the electrical connection of the electrodes of the terminal cells of the strip, the cells in series being connected together within the strip, and the fluidic connection notably making possible the circulation of the hydrogen feeding the anodic face of the cells.

It is possible to dissociate the electrical connection and the fluidic connection but this solution does not make it possible to retain the compactness of the cell and notably of the wound cell.

In this context, the presently disclosed embodiment proposes a connection device that is compact and combines the fluidic connection part for the circulation of hydrogen and the electrical connection part.

For this, the presently disclosed embodiment proposes a fuel cell connection device with strip bearing cells and spiral-wound, which comprises a tube, provided with an electricity-conducting outer surface and an axial electrical connection termination, said tube being further provided with a connection termination for a first gas and radial openings for the passage of said first gas, the tube forming a distribution channel for the first gas between the connection termination for the first gas and the radial openings, the device comprising an electrically insulating tubular sleeve for receiving the tube, the tubular sleeve being provided with a longitudinal window open facing the openings on one side of the tubular sleeve.

Advantageously, the connection termination for the first gas is an axial termination of the tube surrounded by the axial electrical connection termination.

The device can notably comprise an outer connection end fitting connected to the tube serving as electrical and fluidic connector inserted into the tubular sleeve and protruding from the tubular sleeve.

According to a first aspect of the disclosed embodiment, the device constitutes a central connection device for the cell and comprises a cap forming, with the tubular sleeve, a winding mandrel for the cell.

According to a second aspect of the disclosed embodiment, the device constitutes a peripheral connection device for the cell and comprises a cap forming, with the tubular sleeve, a bearing strip termination element.

The presently disclosed embodiment further relates to a fuel cell with spiral-wound cell-bearing strip, for which the cells arranged on the bearing strip are linked in series by wraps forming gas diffusion layers and electrical links between anodes and cathodes of the successive cells, the bearing strip being covered with a cover provided with longitudinal channels for the passage of the first gas and comprising at least one connection device according to the presently disclosed embodiment, for which the tube of said at least one connection device is electrically linked to an end of a terminal wrap and for which the openings are connected with the longitudinal channels through the window of the tubular sleeve.

According to a first aspect of the disclosed embodiment of the cell, the end of the terminal wrap is inserted between the tube and the tubular sleeve, the tubular sleeve pressing the end of the wrap onto the tube to produce an electrical continuity between the tube and the wrap.

Advantageously, the connection device further comprises a cap pressed onto the tubular sleeve and securing, between the tubular sleeve and the cap, an end of the bearing strip protruding from the end of the cover.

The cap can in particular cover the window and keep the cover bearing on the tubular sleeve, the longitudinal channels being thus kept facing the window and connected with the openings of the tube.

More particularly, the device is advantageously central to the spiral and the spiral is wound around the tubular sleeve and the cap configured as a mandrel.

According to a second aspect of the disclosed embodiment of the cell, the tubular sleeve comprises a longitudinal cutout on a side of the tubular sleeve opposite the side bearing the window, said cutout allowing a part of the outer face of the tube to protrude producing an electrical connection surface between the tube and the terminal wrap.

In this context, the tubular sleeve is advantageously pressed onto the bearing strip provided with at least one cutout for connecting the channels of the cover with the window of the tubular sleeve.

Advantageously, the connection device of this second aspect of the disclosed embodiment further comprises a cap pressed onto the tubular sleeve and securing, between the tubular sleeve and the cap, said terminal wrap and pressing said terminal wrap against the connection surface.

The cap can notably be configured as a winding guide for a terminal outer turn of the cover.

Advantageously, the cap and the tubular sleeve comprise complementary snap-fitting forms, and comprise a concave bottom face pressed onto the outside of the winding of the cell.

The cell can notably comprise a winding of a strap with transverse splines forming passages for a second gas at right angles to the winding of the cell, said winding being stopped under the cap and against the tubular sleeve.

The second gas is advantageously air being charged with water vapor at the cell level.

The first gas is advantageously the reactive hydrogen of the cell.

### BRIEF DESCRIPTION OF THE DRAWINGS

Other features and advantages of the aspects of the disclosed embodiment will become apparent on reading the following description of a non-limiting exemplary aspects of the disclosed embodiment with reference to the drawings which represent

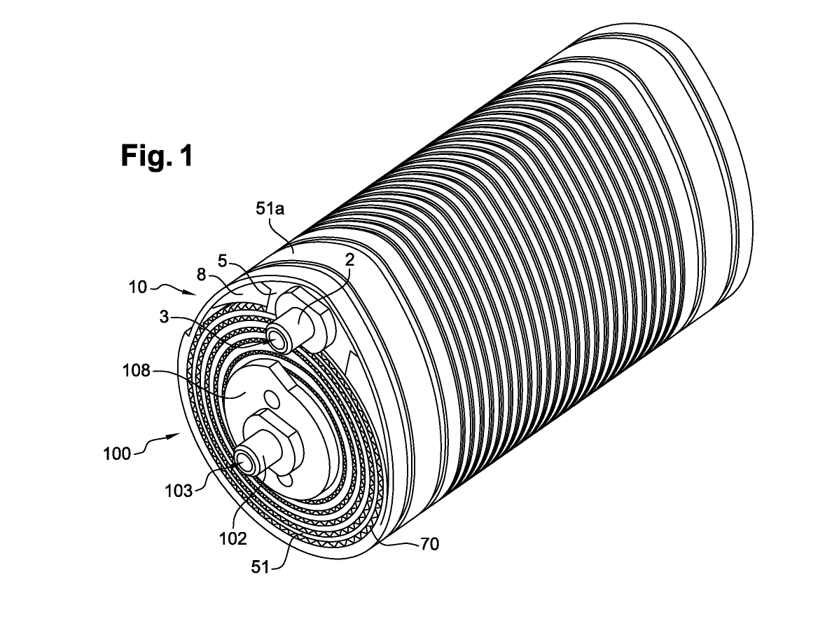

in FIG. 1: a perspective view of a spiral-wound fuel cell provided with connection devices of the invention;

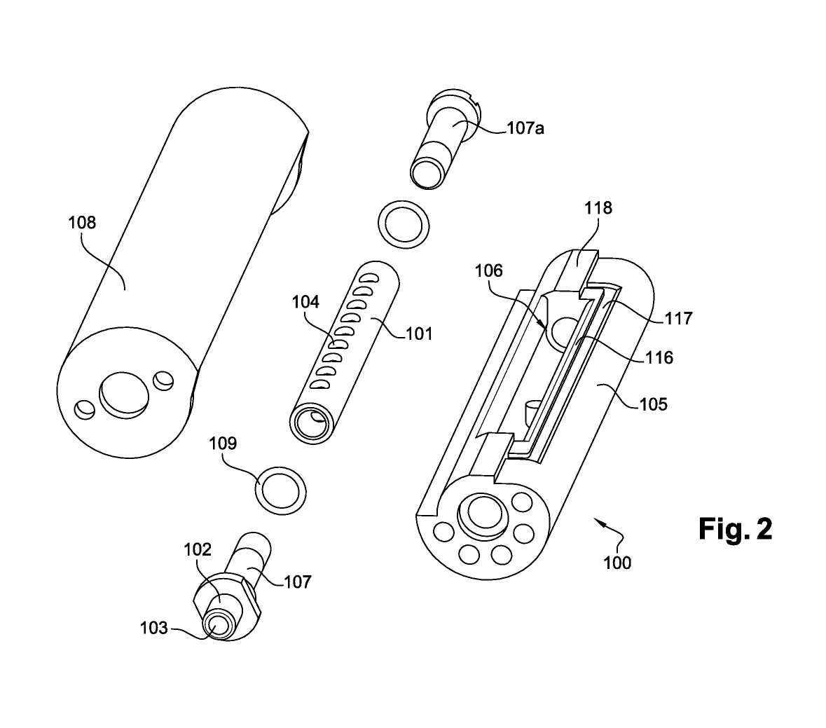

in FIG. 2: an exploded view of a connection device of the invention according to a first aspect of the disclosed embodiment;

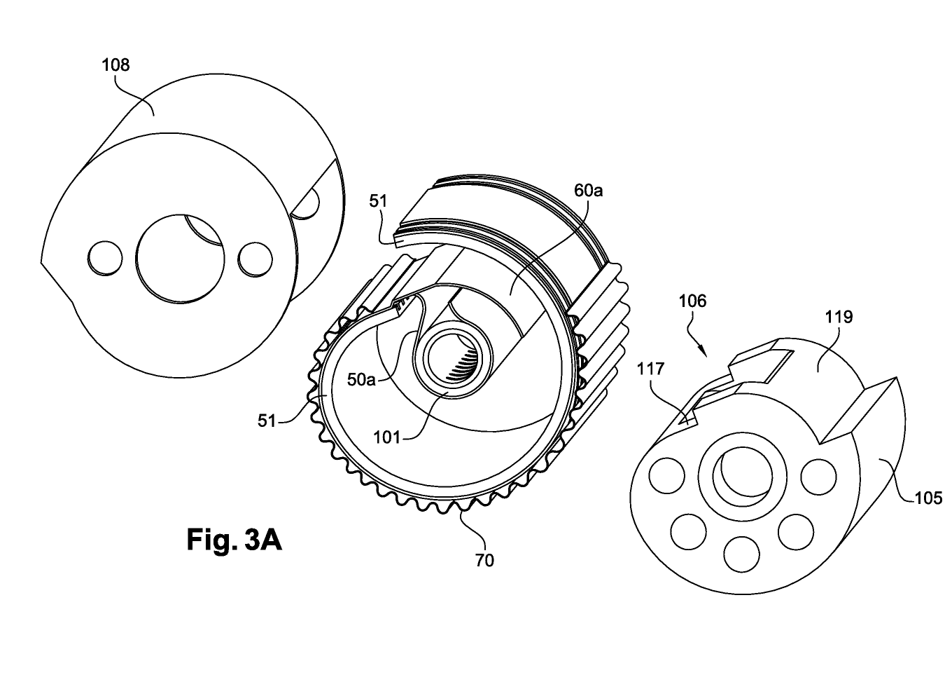

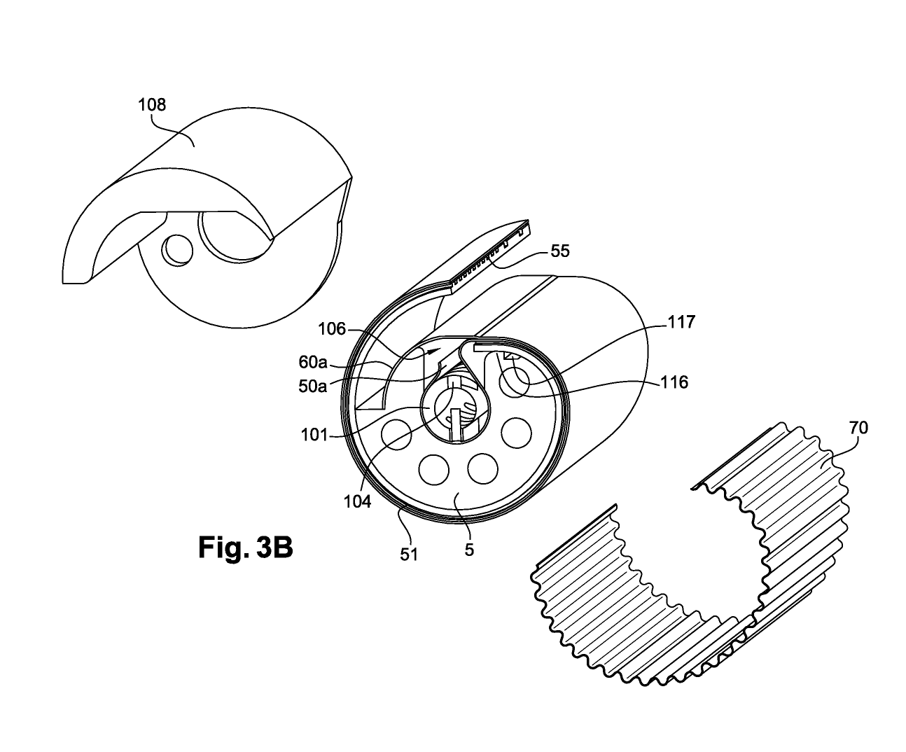

in FIG. 3A: an exploded view of the device of FIG. 1 partially connected to the cell;

in FIG. 3B: a cross-sectional exploded view of the device of FIG. 3A mirrored;

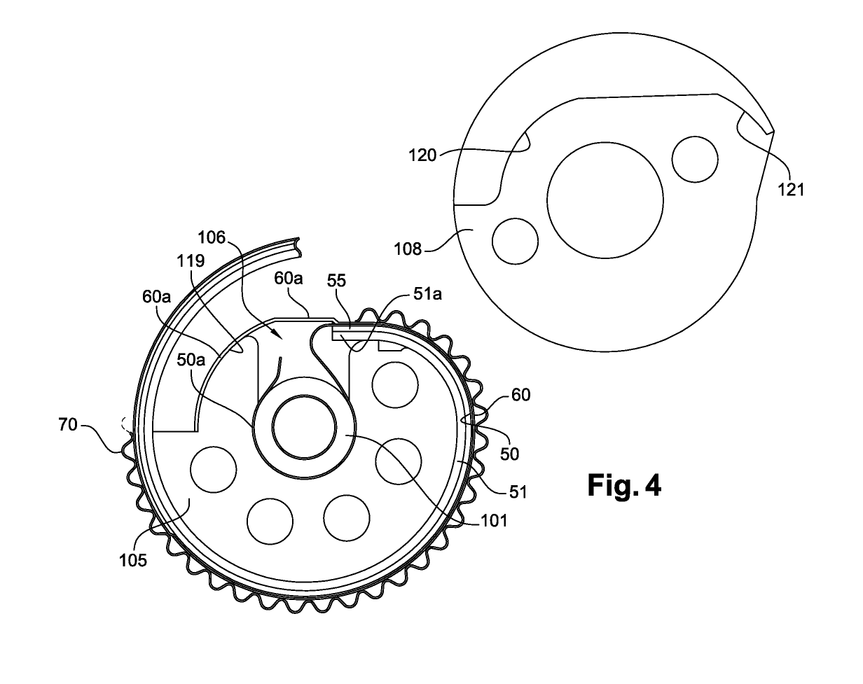

in FIG. 4: a front cross-sectional view of the device of FIG. 3A;

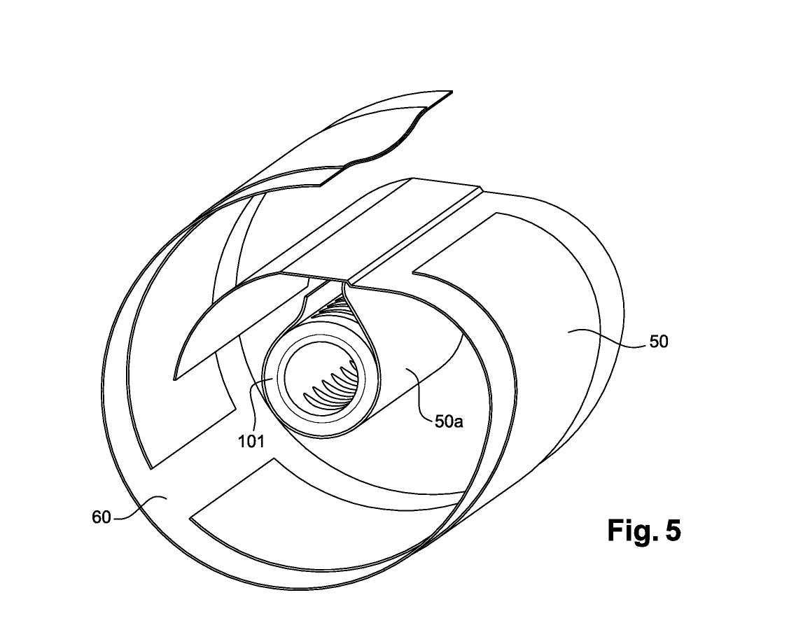

in FIG. 5: a perspective view of the connection of a tube of the device of FIG. 3A on a cell-bearing strip of the fuel cell;

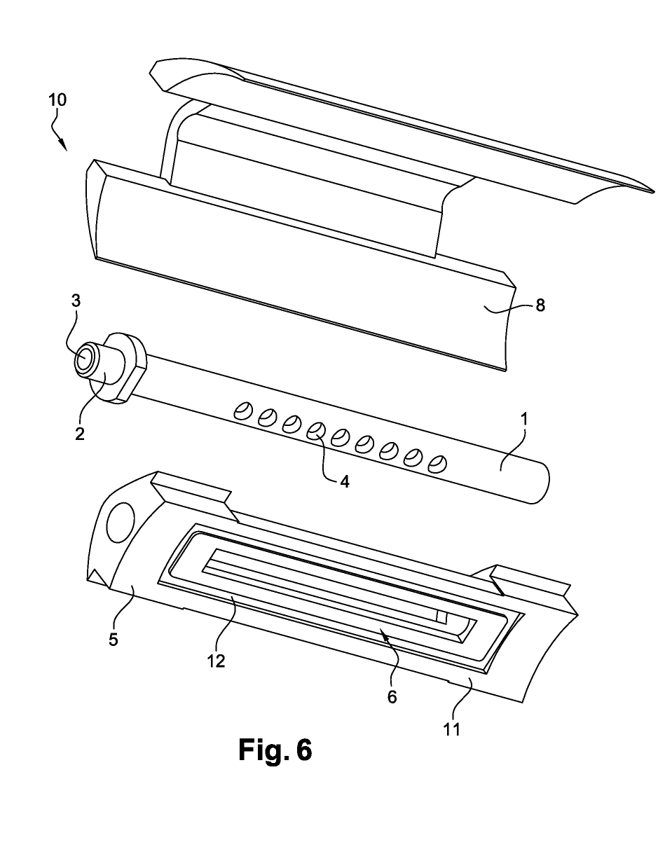

in FIG. 6: an exploded view of a connection device of the invention according to a second aspect of the disclosed embodiment;

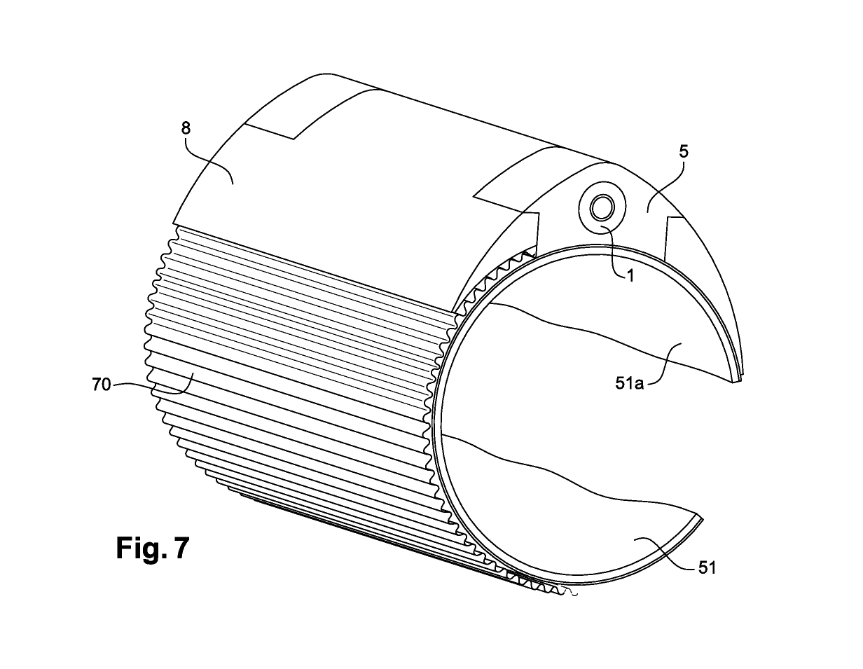

in FIG. 7: a perspective view of the device of FIG. 6 positioned on the fuel cell;

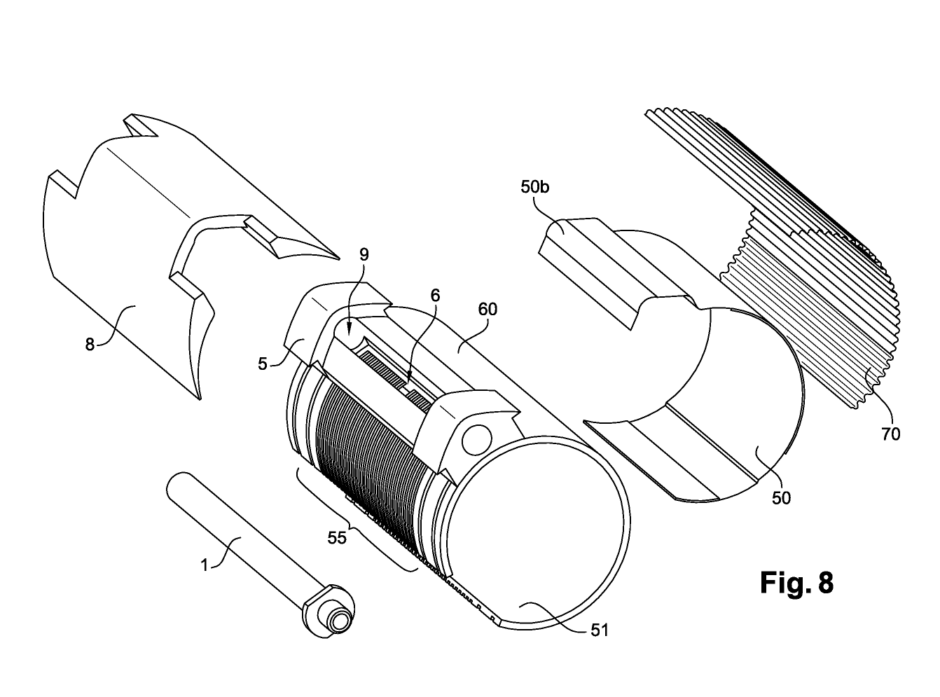

in FIG. 8: an exploded view of the connection of the device of FIG. 7 partially dismantled;

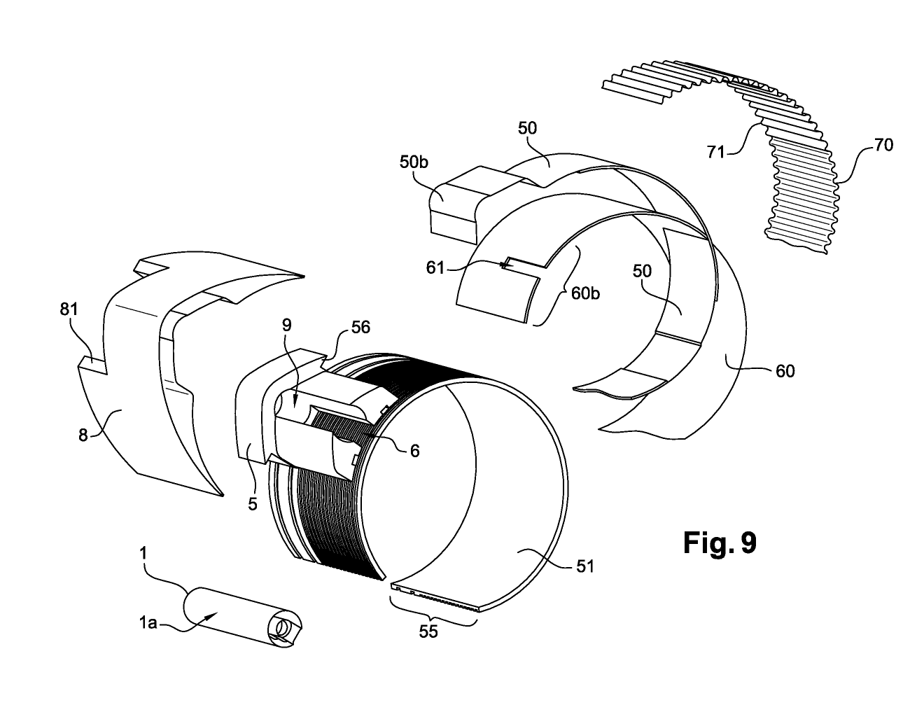

in FIG. 9: a cross-sectional exploded view of the connection of FIG. 8 according to a second dismantling step.

### DETAILED DESCRIPTION

The presently disclosed embodiment relates to a spiral-wound type fuel cell connection device comprising a strip bearing unitary electrochemical cells linked in series, an example of which is given in FIG. 1.

For its connection, the fuel cell comprises two connection devices, one central 100 and the other outer 10 arranged at the periphery of the fuel cell.

These connection devices comprise connection bushings 2, 102 and gas input/output orifices 3, 103 causing the hydrogen to circulate in the fuel cell.

The fuel cell according to the example comprises, in addition to the strip bearing unitary cells, a flexible cover 51, for example made of a molded elastomer material, provided with channels for the distribution of the gas to the cells and comprises a corrugated strap 70 allowing for the circulation of fuel cell cooling air and the evacuation of the water vapor generated by the electrochemical reaction of the fuel cell.

For the operation and the architecture of the fuel cell, reference should be made to the documents FR 2 880 994 A1 and FR 2 958 800 A1 mentioned above. It will however be recalled that the fuel cell comprises a strip bearing unitary cells which have their cathodes on one face of the bearing strip and their anodes on the other face of the bearing strip, the cathode of a cell n being linked to the anode of a cell n+1 by a conductive wrap passing through the bearing strip between the cell n and the cell n+1, a circulation of hydrogen on the anode side and a circulation of air on the cathode side being produced to make the fuel cell operate.

As will be seen in more detail below, the central connection device 100 comprises a cap 108 and the outer connection device comprises a cap 8, the cap 108 of the central connection device assisting in the winding of the start of the spiral and the cap 8 of the outer connection device making it possible to terminate the winding of the spiral (the start of the spiral being defined as being at the center of the spiral).

According to FIGS. 2 and 6, the connection device of the disclosed embodiment comprises two main parts, namely a tube 1, 101 and a tubular sleeve 5, 105 receiving the tube.

The tube is provided with an electricity-conducting outer surface and an axial electrical connection termination 2, 102.

The tube can notably be made of copper which is a good conductor of electricity.

The tube is further provided with a connection termination 3, 103 for a first gas and radial openings 4, 104 for the passage of said first gas, the tube forming a distribution channel for the first gas between the connection termination and the radial openings.

The radial openings here are holes of circular section distributed along the tube and connected with the interior of the tube but can, in an equivalent manner, be replaced by one or more oblong or rectangular openings.

The tubular sleeve 5, 105 is an electrically insulating tubular sleeve which is provided with a longitudinal window 6, 106 open facing the openings on one side of the tubular sleeve.

The connection termination 3, 103 for the first gas is an axial termination of the tube surrounded by the axial electrical connection termination 2, 102.

According to the example of FIG. 2, for which the connection device is a central inner connection device of the fuel cell commencing the winding of the fuel cell, the device comprises an outer connection end fitting 107 connected to the tube serving as electrical and fluidic connector inserted into the tubular sleeve 105 and protruding from the tubular sleeve.

According to the example represented, an O-ring seal 109 renders the assembly of the end fitting 107 on the tubular sleeve 105 leak-tight.

The O-ring seal can, however, be replaced by a glue seal, an overmolding or a seal directly produced by two-material injection.

The aim of this seal is to control the channeling of the gas between the sleeve formed by the cell-bearing strip and the strip splined for the hydrogen and direct the gas to a power supply coupling.

The window 106 is a rectangular window, one of the longs sides framing the window comprising a bearing face 116 and a groove 117, the small sides of the frame of the window comprising shoulders 118.

According to the example of FIG. 6 for which the connection device is an outer connection device terminating the spiral of the fuel cell, the outer connection 2 forms part of the tube, the tubular sleeve 5 here being preferably a tubular sleeve overmolded on the tube 1 although an add-on tubular sleeve can also be used.

The window 6 is, for this aspect, framed by a peripheral bearing surface 11 provided with a groove 12.

The connection of the fuel cell to the connection device 100, with the central connection device of the fuel cell at the center of the spiral formed by the fuel cell, is detailed in FIGS. 3 to 5.

According to FIG. 3B representing, in cross-section, the assembly of the winding of the fuel cell on the tubular sleeve 5, the cover 51 is shown in position bearing on the bearing face 116, the bearing face and the groove 117 being adapted to produce a bonding of the cover on the tubular sleeve and to have a leak-tight seal in the groove 117 to produce a leak-tight link between the end of the elastomer cover and the tubular sleeve.

It should be noted that the tubular sleeve 5 can also be overmolded on the strip, the groove 117 not in this case being necessary.

The cover is stopped by the shoulders 118 and its end is overhanging in the window above the housing of the tube to place the channels 55 produced in the cover in connection with the openings of the tube emerging in the housing under the window 106.

The cross-sectional view of FIG. 4 represents the end 51a of the cover 51 positioned in the window 106.

This figure shows the end 50a of a first wrap 50 linking the first unitary cell of the fuel cell to the tube 101 (the first cell is defined as that closest to the center of the winding and the last as the one terminating the fuel cell at the periphery of the winding).

This first wrap end 50a is wound around the tube and kept in contact with the tube by the tubular sleeve 105 in which the tube is housed.

FIG. 5 represents the tube 101 on which the end of the wrap 50a is wound and the start of the strip 60 bearing the electrochemical conversion cells.

In FIG. 4, the tubular sleeve, the cover and the strap have been removed for a better view of the winding.

FIG. 3A represents the start of the fuel cell with, this time, the start of the cover 51, which is situated under the bearing strip 60 and the wrap 50 whose ends 60a and 50a are represented, and the start of the corrugated strap 70.

In this figure, the tubular sleeve 105 and the cap 108 are separated so as to represent a curved face 119 of the tubular sleeve 105 onto which the termination 60a of the bearing strip is pressed.

The position of the termination 60a on the tubular sleeve is further represented in FIG. 4 where a key-form 120 can also be seen, produced under the cap 108, this key-form being pressed onto the termination 60a retained between the curved face 119 of the tubular sleeve and the key-form 120.

This figure further makes it possible to distinguish the position of the start of the strap 70 which is held by a nose 121 of the cap.

To connect the connection device to the end of the cell:
the cover and the strap are cut to allow the end of the bearing strip 60a and the end 50a of the wrap to protrude,
the cover is glued with a leak-tight seal onto the bearing surface 116, the groove 117 forming a reserve for the seal,
the end of the wrap 50a is slid between the tube and the tubular sleeve,
the end 60a of the bearing strip is positioned on the curved face 119 on the side of the window opposite the bearing face receiving the cover, and
the cap 108 is pressed onto the assembly to close the window and hold the elements of the fuel cell in place.

The assembly is then fixed by the insertion of the end fittings 107 and 107a of FIG. 2 which block the cap in position on the tubular sleeve.

The cap and the tubular sleeve then serve as a mandrel to begin the winding of the fuel cell, the connection device thus constituting a central connection device 10 of the fuel cell and which comprises a cap 108 forming, with the tubular sleeve 105, a winding mandrel for the fuel cell.

It should be noted that, according to FIG. 3b in particular, the wrap end 50a is interposed between the openings 104 and the channels 55 (masked by the perspective) in the housing under the window 106.

This is not a problem for the circulation of hydrogen because the wrap is a porous material that allows the gas to pass through.

Furthermore, it is possible to conceive winding the wrap on the tube in the direction opposite the direction represented in the figures.

The connection of the device of FIG. 6 is detailed in FIGS. 7 to 9.

According to FIG. 7, this device constitutes a peripheral connection device 10 of the fuel cell, that is to say a connection device terminating the fuel cell at the periphery of the fuel cell. It comprises a cap 8 forming, with the tubular sleeve 5, a termination element of the bearing strip which is pressed onto the end of the bearing strip 60, cover 51 and strap 70 assembly.

A bottom part of the cap and of the tubular sleeve closely follows the curvature of the terminal winding of the fuel cell whereas, as represented in FIG. 1, the top parts of the cap and of the tubular sleeve are produced with a curvature suited to making it possible to cover the fuel cell with an additional strand 51a of the cover 51 to protect the fuel cell.

In FIG. 8, the cap 8, the strap 70, the wrap 50 and the tube 1 have been separated to make it possible to view the positioning of the tubular sleeve 5.

On the side opposite the window 6, the tubular sleeve 5 comprises a cutout 9 through which one side of the tube 1 protrudes.

To produce the electrical connection between the tube 1 and the termination 50b of the wrap 50, this termination is laid on the top part of the tubular sleeve 5 and is connected on the side of the tube 1 flush with or protruding from the cutout 9.

The electrical contact is ensured by the cap 8, which, once snap-fitted or assembled with the tubular sleeve 5, bears on the termination of the wrap and presses it against the tube.

For the gas connection, the openings of the tube (here not visible because facing downward) are arranged facing the window 6 which is itself above the channels 55 of the cover 51.

According to FIG. 8, the end of the bearing strip is arranged under the tubular sleeve 5, so as to form a planar surface that makes it possible to produce a leak-tight connection by the arrangement of a seal at the level of the bearing surface 11 and of the groove 12 represented in FIG. 6 where the tubular sleeve is seen from below.

To ensure the gas connection between the openings of the tube 1 and the channels 55, the bearing strip comprises a cutout 61 for connecting the channels 55 of the elastomer cover 51 with the window 6 of the tubular sleeve. This cutout is represented in FIG. 9 where the bearing strip has been separated from the tubular sleeve.

Thus, the connection of the end of the winding of the fuel cell is produced as follows:
the bearing strip 60 is terminated by a segment 60b of the width of the tubular sleeve 5 and provided with the cutout 61;
the strap is cut so that it stops on an outer edge of the tubular sleeve 5;
a length of the cover suitable for producing approximately an additional one and a half turns relative to the end of the bearing strip is retained;
the termination 50b of the last wrap of the fuel cell is bent;
the tubular sleeve is tightly glued onto the segment 60b, the cutout 61 being arranged under the window 6 to leave the channels 55 of the cover 51 visible;
the termination 50b is positioned on the tubular sleeve and the cap 8 is snap-fitted onto the tubular sleeve 5.

Finally, the connection device and the cap are surrounded by the additional length of cover and it is glued onto the previous winding where it is fixed with an adhesive device or a collar.

The splined strap 70 is clamped under the cap and in abutment against the tubular sleeve 5 as represented in FIG. 7.

To fix the tubular sleeve 5 and the cap 8, the cap 8 and the tubular sleeve 5 comprise complementary snap-fitting forms 81, 56.

The concave bottom face of the tubular sleeve and the bottom face of the cap are pressed onto the outside of the winding of the fuel cell, the outer connector further being able to be produced in a flexible elastomer material to match the form of different windings.

The cover 51 can notably be made of an elastomer material of sufficient hardness to produce the channel partitions and flexible so it can be wound.

The strap is, for its part, made from a material such as a plastic material designed to retain its form once corrugated and wound in the fuel cell.

The disclosed embodiment is not limited to the example represented, the electrical connection terminals notably being able to comprise terminals or bearing means for an electrical contact.

What is claimed is:

1. A fuel cell connection device with strip bearing cells and spiral wound, the fuel cell connection device comprising: a tube, provided with an electricity-conducting outer surface and an axial electrical connection termination, said tube being further provided with a connection termination for a first gas and radial openings for the passage of said first gas, the tube forming a distribution channel for the first gas between the connection termination for the first gas and the radial openings, the device further comprising an electrically insulating tubular sleeve for receiving the tube, the tubular sleeve being provided with a longitudinal window open facing the openings on one side of the tubular sleeve.

2. The fuel cell connection device as claimed in claim 1, wherein the connection termination for the first gas is an axial termination of the tube surrounded by the axial electrical connection termination.

3. The fuel cell connection device as claimed in claim 1, further comprising an outer connection end fitting connected to the tube serving as electrical and fluidic connector inserted into the tubular sleeve and protruding from the tubular sleeve.

4. The connection device as claimed in claim 3, wherein it constitutes a central connection device for the fuel cell and comprises a cap forming, with the tubular sleeve, a winding mandrel for the fuel cell.

5. The connection device as claimed in claim 4, wherein it constitutes a peripheral connection device for the fuel cell and comprises a cap forming, with the tubular sleeve, a bearing strip termination element.

6. A fuel cell with a spiral-wound cell-bearing strip, for which the cells arranged on the bearing strip are linked in series by wraps forming gas diffusion layers and electrical links between anodes and cathodes of the successive cells, the bearing strip being covered with a cover provided with longitudinal channels for the passage of the first gas and comprising at least one connection device as claimed in claim 1, wherein the tube of said at least one connection device is electrically linked to an end of a terminal wrap and in that the openings are connected with the longitudinal channels through the window of the tubular sleeve.

7. The fuel cell with the spiral-wound cell-bearing strip as claimed in claim 6, wherein the end of the terminal wrap is inserted between the tube and the tubular sleeve, the tubular sleeve pressing the end of the wrap onto the tube to produce an electrical continuity between the tube and the wrap.

8. The fuel cell with the spiral-wound cell-bearing strip as claimed in claim 7, wherein the connection device further comprises a cap pressed onto the tubular sleeve and securing, between the tubular sleeve and the cap, an end of the bearing strip protruding from the end of the cover.

9. The fuel cell with the spiral-wound cell-bearing strip as claimed in claim 8, wherein the cap covers the window and keeps the cover bearing on the tubular sleeve, the longitudinal channels being thus kept facing the window and connected with the openings of the tube.

10. The fuel cell with the spiral-wound cell-bearing strip as claimed in claim 9, wherein said device is a device central to the spiral for which the spiral is wound around the tubular sleeve and the cap configured as a mandrel.

11. The fuel cell with to spiral-wound cell-bearing strip as claimed in claim 6, wherein the tubular sleeve comprises a longitudinal cutout on a side of the tubular sleeve opposite the side bearing the window, said cutout allowing a part of the outer face of the tube to protrude producing an electrical connection surface between the tube and the terminal wrap.

12. The fuel cell with spiral-wound cell-bearing strip as claimed in claim 11, wherein the tubular sleeve is pressed onto the bearing strip provided with at least one cutout for connecting the channels of the cover with the window of the tubular sleeve.

13. The fuel cell with spiral-wound cell-bearing strip as claimed in claim 11, wherein the connection device further comprises a cap pressed onto the tubular sleeve and securing, between the tubular sleeve and the cap, said terminal wrap and pressing said terminal wrap against the connection surface.

14. The fuel cell with spiral-wound cell-bearing strip as claimed in claim 13, wherein the cap is configured as a winding guide for a terminal outer turn ) of the cover.

15. The fuel cell with the spiral-wound cell-bearing strip as claimed in claim 13, wherein the cap and the tubular sleeve comprise complementary snap-fitting forms, and further comprise a concave bottom face pressed onto the outside of the winding of the fuel cell.

16. The fuel cell with the spiral-wound cell-bearing strip as claimed in claim 8, further comprising a winding of a strap with transverse splines forming passages for a second gas at right angles to the winding of the cell, said winding being stopped under the cap and against the tubular sleeve.

17. The fuel cell with the spiral-wound cell-bearing strip as claimed in claim 16, wherein the second gas is air being charged with water vapor at the cell level.

18. The fuel cell with the spiral-wound cell-bearing strip as claimed in claim 6, wherein the first gas is a reactive hydrogen of the fuel cell.
